(19) United States
(12) Patent Application Publication
(10) Pub. No.: US 2022/0128458 A1
(43) Pub. Date: Apr. 28, 2022

(54) SPECTROMETER

(71) Applicant: InnoSpectra Corporation, Hsin-Chu (TW)

(72) Inventors: Fei-Peng Chang, Hsin-Chu (TW); Hsi-Pin Li, Hsin-Chu (TW)

(73) Assignee: InnoSpectra Corporation, Hsin-Chu (TW)

(21) Appl. No.: 17/505,630

(22) Filed: Oct. 20, 2021

(30) Foreign Application Priority Data
Oct. 23, 2020 (CN) 202022383495.4

(51) Int. Cl. G01N 21/31; G01N 21/01

(52) U.S. Cl. CPC G01N 21/31; G01N 2201/022; G01N 21/01

(57) ABSTRACT

The disclosure provides a spectrometer, which includes a housing and a spectrum measurement module. The housing has an arrangement surface and an opening. The spectrum measurement module is disposed in the housing and has a measurement surface. The measurement surface is exposed from the opening of the housing, and there is a height difference between the measurement surface and the arrangement surface.

### CROSS-REFERENCE TO RELATED APPLICATION

This application claims the priority benefit of China application serial no. 202022383495.4, filed on Oct. 23, 2020. The entirety of the above-mentioned patent application is hereby incorporated by reference herein and made a part of this specification.

### BACKGROUND

### 1. Technical Field

The disclosure relates to an optical measuring device, and particularly relates to a spectrometer.

### 2. Description of Related Art

The existing diffuse reflectance sampling spectrometer is mostly used to measure substances that are impenetrable to light. Light emitted by the light source is projected on the sample to be measured, diffusely reflected back to the spectrometer by the sample to be measured, and the spectral signal of the sample to be measured may be recorded. If a diffuse reflectance spectrometer is to be used to measure liquid that is penetrable to light, an additional fixture is usually needed to fix the sample to be measured and the reference white sample having high diffuse reflectance, such that the light emitted by the light source may penetrate the sample to be measured, then reflected by the reference white sample and return to the spectrometer, and the spectral signal of the sample to be measured may be recorded. The existing spectrometer usually does not come with a fixture for fixing the cuvette and the reference white sample, and the system integrator must make an additional fixture for fixing the cuvette and the reference white sample. In addition, when the existing reflectance spectrometer is used to measure penetrable samples, the light passing through the liquid to be measured and then reflected by the reference white sample will pass through the liquid to be measured once more, and the optical path becomes double. Therefore, the spectral efficiency after entering the spectrometer is usually very poor, resulting in a poor signal-to-noise ratio of the spectrum.

The information disclosed in this background section is only for enhancement of understanding of the background of the described technology and therefore it may contain information that does not form the prior art that is already known to a person of ordinary skill in the art. Further, the information disclosed in the background section does not mean that one or more problems to be resolved by one or more embodiments of the invention was acknowledged by a person of ordinary skill in the art.

### SUMMARY

The disclosure provides a spectrometer that may obtain better spectral quality.

Other objectives and advantages of the disclosure may be further understood from the technical features disclosed in the disclosure.

In order to achieve one or part or all of the above objects or other objects, an embodiment of the disclosure provides a spectrometer including a housing and a spectrum measurement module. The housing has an arrangement surface and an opening. The spectrum measurement module is disposed in the housing and has a measurement surface. The measurement surface is exposed from the opening of the housing, and there is a height difference between the measurement surface and the arrangement surface.

In order to achieve one or part or all of the above objects or other objects, an embodiment of the disclosure provides a spectrometer including a housing, a spectrum measurement module, and a transflective assembly. The housing has an arrangement surface and an opening. The spectrum measurement module is disposed in the housing and has a measurement surface. The measurement surface is exposed from the opening of the housing, and there is a height difference between the measurement surface and the arrangement surface. The transflective assembly is detachably assembled on the housing, and includes a holder and a cuvette. The cuvette is configured to contain the liquid to be measured, and the cuvette is fixed on the holder and attached to the measuring surface of the spectrum measuring module.

Base on the above, the embodiments of the disclosure have at least one of the following advantages or effects. In the design of the spectrometer of the disclosure, the measurement surface of the spectrum measurement module is exposed from the opening of the housing, and there is a height difference between the measurement surface and the arrangement surface. Thereby, it may be ensured that the sample to be measured can first contact the measuring surface without being affected by the housing, such that the spectrometer of the disclosure may obtain better spectral quality.

Other objectives, features and advantages of the present invention will be further understood from the further technological features disclosed by the embodiments of the present invention where there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of the disclosure. The drawings illustrate embodiments of the disclosure and, together with the description, serve to explain the principles of the disclosure.

FIG. 1A is a three-dimensional schematic view of a spectrometer according to an embodiment of the disclosure.

FIG. 1B is a schematic side view of a spectrometer of FIG. 1A.

FIG. 2A is a three-dimensional schematic view of another spectrometer according to an embodiment of the disclosure.

FIG. 2B is a three-dimensional schematic view of a reference white assembly in FIG. 2A removed from a spectrum measurement module.

FIG. 2C is a three-dimensional exploded schematic view of a reference white assembly in FIG. 2A.

FIG. 2D is a schematic side view of a reference white assembly of FIG. 2C.

FIG. 3A is a partial perspective view of a spectrometer according to another embodiment of the disclosure.

FIG. 3B is a perspective schematic view of a transflective assembly of FIG. 3A detached from a housing.

FIG. 3C is a perspective schematic view of a holder of a transflective assembly of FIG. 3A.

FIG. 3D is a perspective partial exploded schematic view of a transflective assembly of FIG. 3A.

FIG. 3E to FIG. 3F are three-dimensional schematic views of a reference white sample holder and a cuvette sequentially disposed on the holder in FIG. 3D.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

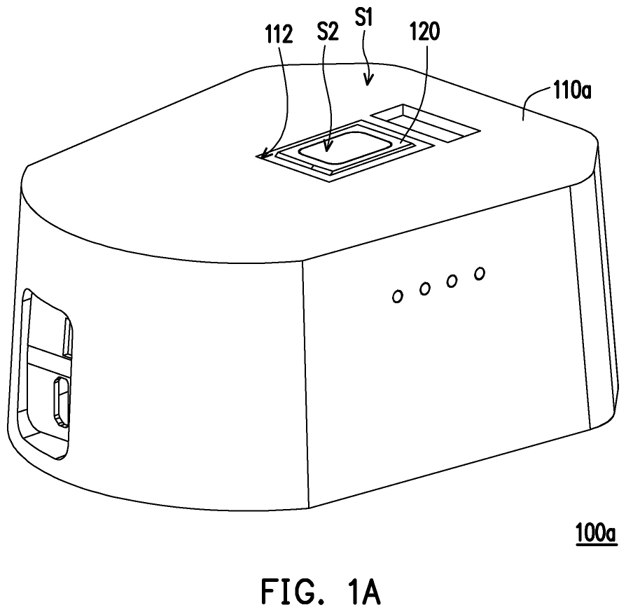

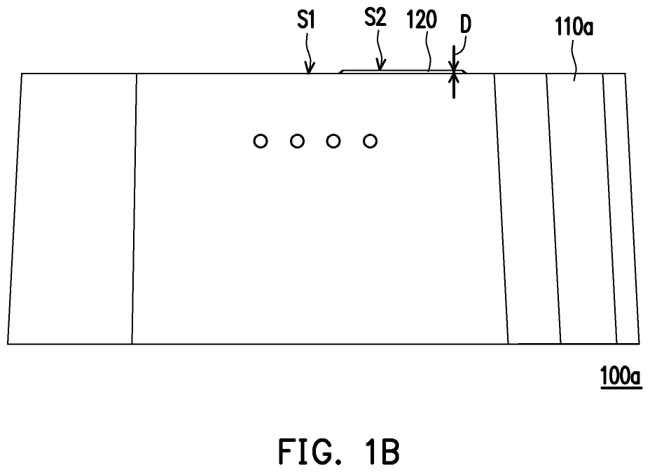

FIG. 1A is a three-dimensional schematic view of a spectrometer according to an embodiment of the disclosure. FIG. 1B is a schematic side view of a spectrometer of FIG. 1A. Please refer to FIG. 1A and FIG. 1B at the same time. In the present embodiment, a spectrometer 100a includes a housing 110a and a spectrum measurement module 120. The housing 110a has an arrangement surface S1 and an opening 112. The spectrum measurement module 120 is disposed in the housing 110a and has a measurement surface S2. The measurement surface S2 is exposed from the opening 112 of the housing 110a, and there is a height difference D between the measurement surface S2 and the arrangement surface S1. Here, the height difference D is, for example, between 0.1 mm and 5 mm. The height difference D may ensure that a sample to be measured first contacts the measurement surface S2 without being affected by the arrangement surface S1 of the housing 110a.

In detail, the housing 110a may be of any shape, and the measuring surface S2 is embodied as a flat surface, which may respond to the sample to be measured of different exteriors (such as rough surfaced, powdered, with large curved surface or odd shapes), so as to prevent the arrangement surface S1 of the housing 110a from interfering with the measurement of the sample to be measured. Further, the measurement surface S2 of the spectrum measurement module 120 of the present embodiment is exposed from the opening 112 of the housing 110a in an upward manner. Different sizes of different samples may be placed on the measurement surface S2 so as to respectively measure a spectral signal of the sample to be measured, such that the spectrometer 100a of the present embodiment may obtain better spectral quality. Here, the sample to be measured is embodied, for example, as a light-impenetrable substance, and the spectrum measurement module 120 is, for example, a diffuse reflectance spectrum measurement module.

It must be noted here that the following embodiments follow the component numbers and part of the content of the foregoing embodiments, where the same numbers are used to represent the same or similar components, and the description of the same technical content is omitted. Please refer to the foregoing embodiments for the description of the omitted parts, which will not be repeated in the following embodiments.

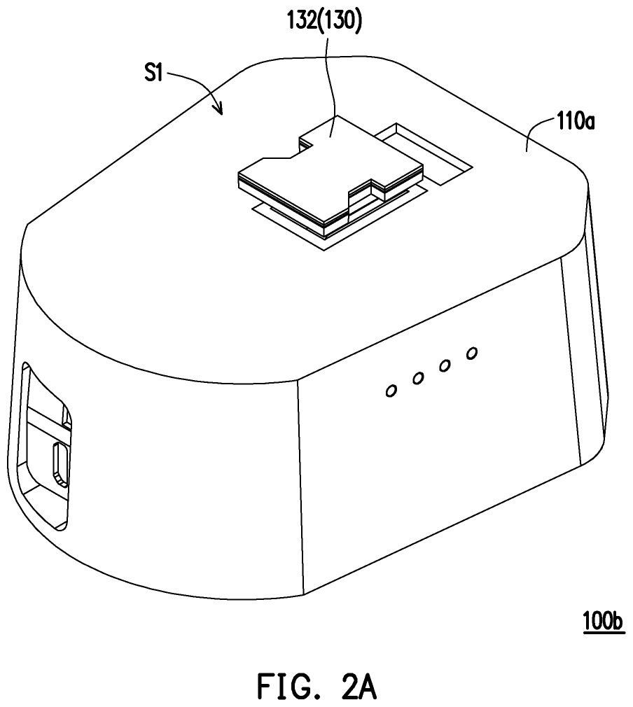

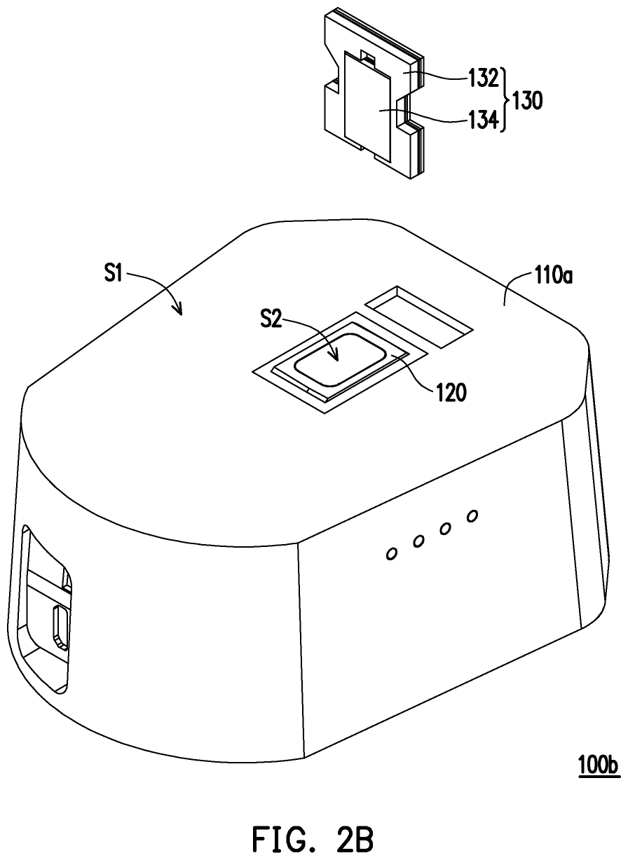

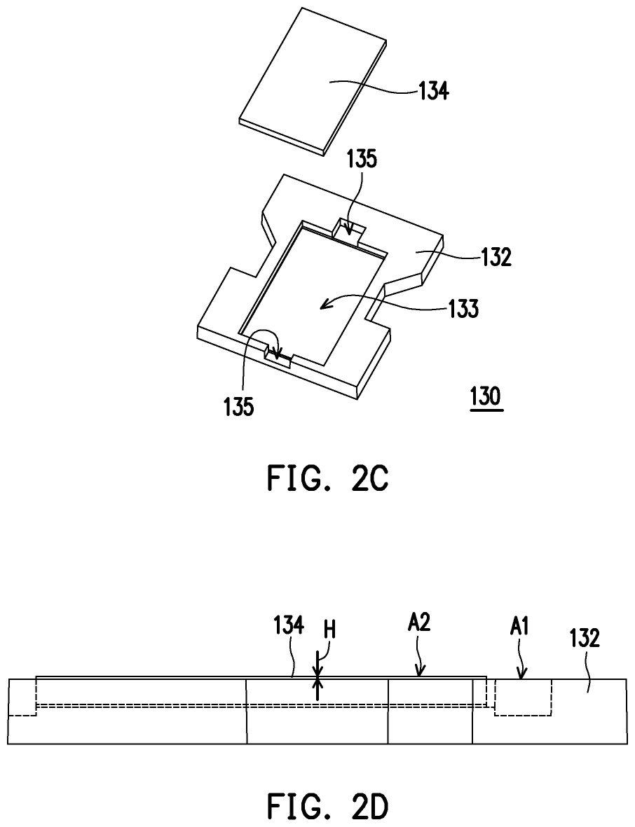

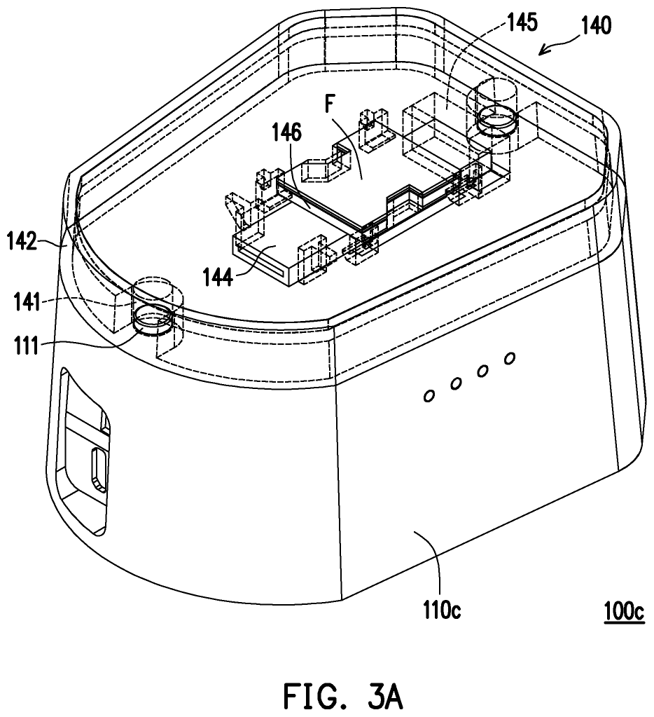

FIG. 2A is a three-dimensional schematic view of another spectrometer according to an embodiment of the disclosure. FIG. 2B is a three-dimensional schematic view of a reference white assembly in FIG. 2A removed from a spectrum measurement module. FIG. 2C is a three-dimensional exploded schematic view of a reference white assembly in FIG. 2A. FIG. 2D is a schematic side view of a reference white assembly of FIG. 2C. Please first refer to FIGS. 1A, 2A, and 2B at the same time. A spectrometer 100b of the present embodiment is similar to the spectrometer 100a of FIG. 1A. The difference between the two is that the spectrometer 100b of the present embodiment further includes a reference white assembly 130, which is removably disposed on the measurement surface S2 of the spectrum measurement module 120.

In detail, please refer to FIGS. 2B and 2C at the same time. The reference white assembly 130 of the present embodiment includes a reference white sample holder 132 and a reference white sample 134. The reference white sample holder 132 has a containment groove 133, and the reference white sample 134 is disposed in the containment groove 133 of the reference white sample holder 132. That is, the reference white sample holder 132 is configured to store and protect the reference white sample 134. Here, the reference white sample 134 is, for example, a white ceramic sheet or a white reflectance sheet, but the disclosure is not limited thereto. Further, the reference white sample holder 132 of the present embodiment further includes at least one glue groove (two glue grooves 135 are schematically shown), wherein the reference white sample 134 is fixed inside the containment groove 133 through a glue placed inside the glue groove 135. In other words, the reference white sample 134 is adhered inside the containment groove 133 through the glue.

Please refer to FIG. 2D. The reference white sample holder 132 of the present embodiment has a first surface A1, and the reference white sample 134 has a second surface A2, wherein the second surface A2 protrudes by a height H relative to the first surface A1. Preferably, the height H is between 0.05 mm and 1 mm. Since the second surface A2 of the reference white sample 134 is higher than the first surface A1 of the reference white sample holder 132, the sample to be measured can first directly contact the reference white sample 134, such that the spectrometer 100b of the present embodiment may obtain better spectral quality. It is worth mentioning that the reference white sample 134 does not serve only as a reflective surface of the penetrating reflectance spectrometer during measurement, but also as a reference signal before measuring any sample to be measured. In other words, before the measurement, the reference white sample is first measured as the reference signal, and then the sample to be measured is measured.

Furthermore, the reference white assembly 130 of the present embodiment is removably disposed on the measurement surface S2 of the spectrum measurement module 120. For example, when the sample to be measured is embodied as a light penetrable substance, the reference white assembly 130 may be disposed on the measurement surface S2 of the spectrum measurement module 120 as shown in FIG. 2A. At this time, the sample to be measured is located between the reference white sample 134 and the measurement surface S2, wherein light emitted by the light source in the spectrum measurement module 120 may directly pass through the sample to be measured and be incident on the reference white sample 134, and the light may be reflected by the reference white sample 134 and again pass through the sample to be measured to return to the spectrum measurement module 120, so as to complete the measurement of the spectrum of the sample to be measured. At this time, the spectrometer 100b of the present embodiment may be regarded as the transflectance spectrometer which measures the spectral signal of the sample to be measured with the diffuse reflectance spectrum measurement module 120.

On the other hand, when the sample to be measured is embodied as a solid substance, the reference white assembly 130 may be removed from the measurement surface S2 of the spectrum measurement module 120 as shown in FIG. 2B. At this time, the sample to be measured is disposed on the measurement surface S2, wherein the light emitted by the light source in the spectrum measurement module 120 is incident on the sample to be measured, and the light is diffusely reflected back to the spectrum measurement module 120 by the sample to be measured, so as to complete the measurement of the spectrum of the sample to be measured.

In short, in the spectrometer 100b of the present embodiment, the reference white assembly 130 may be assembled on the housing 110a so as to measure the light penetrable sample to be measured, or the reference white assembly 130 may be removed from the housing 110a so as to measure the light impenetrable sample to be measured. Therefore, the spectrometer 100b of the present embodiment have a wider range of use and better ease of use.

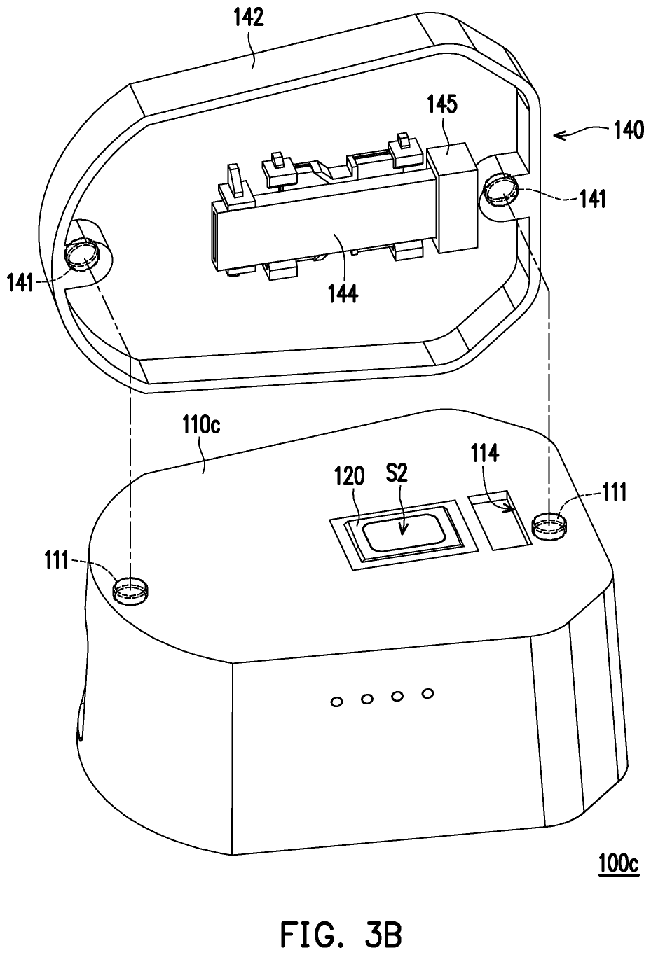

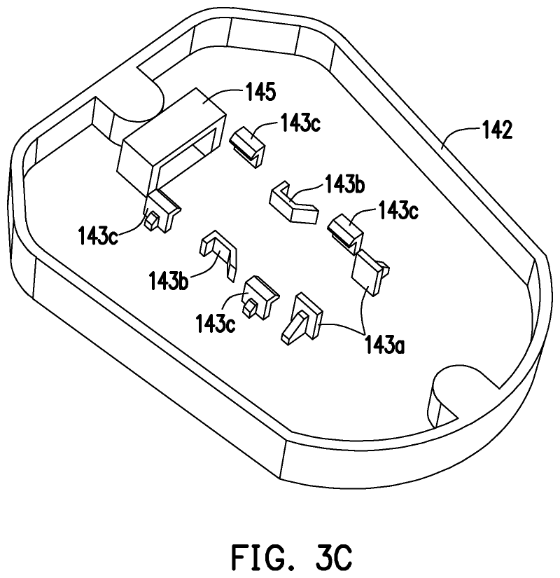

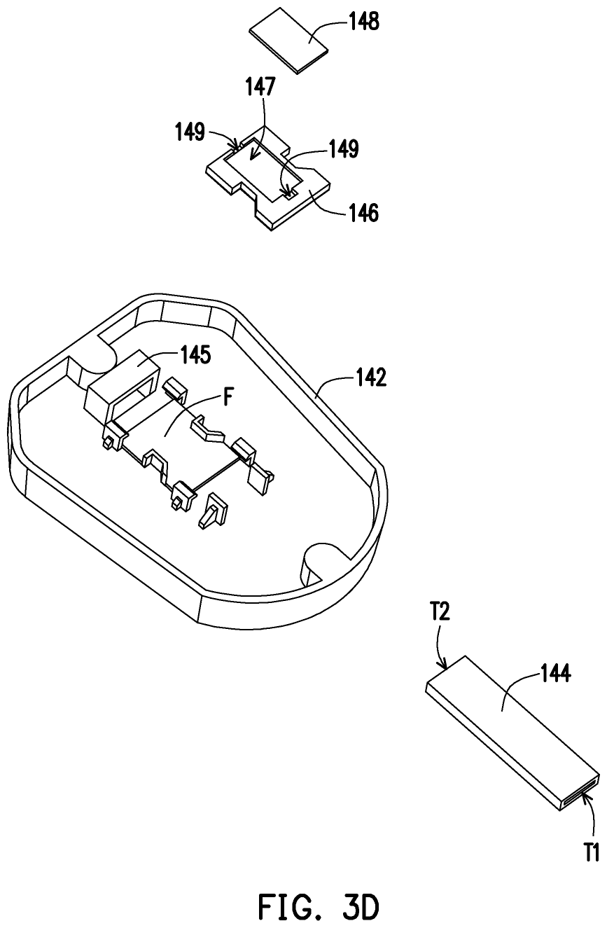

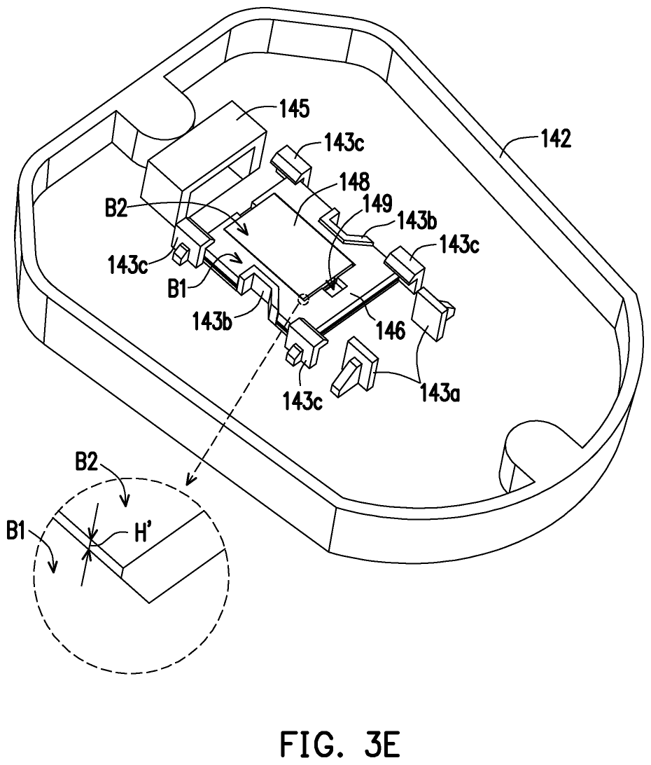

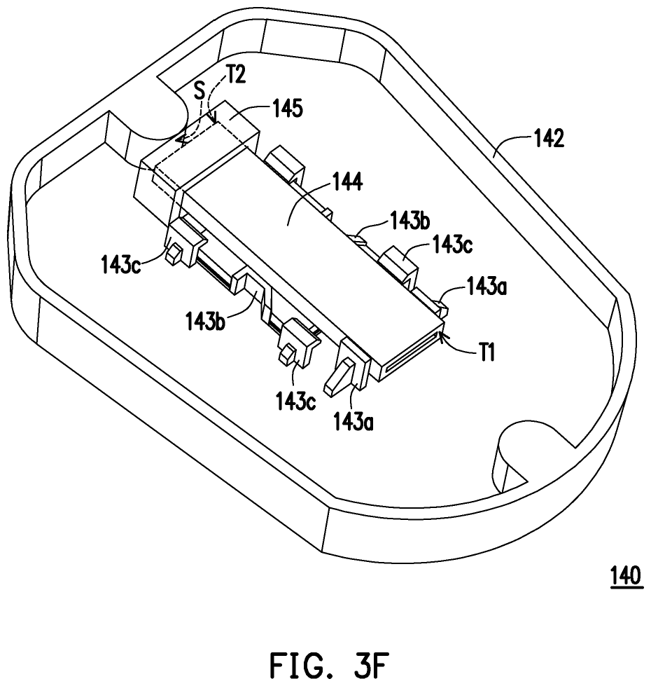

FIG. 3A is a partial perspective view of a spectrometer according to another embodiment of the disclosure. FIG. 3B is a perspective schematic view of a transflective assembly of FIG. 3A detached from a housing. FIG. 3C is a perspective schematic view of a holder of a transflective assembly of FIG. 3A. FIG. 3D is a perspective partial exploded schematic view of a transflective assembly of FIG. 3A. FIG. 3E to FIG. 3F are three-dimensional schematic views of a reference white sample holder and a cuvette sequentially disposed on the holder in FIG. 3D.

Please first refer to FIGS. 1A, 3A, and 3B at the same time. A spectrometer 100c of the present embodiment is similar to the spectrometer 100a of FIG. 1A. The difference between the two is that the spectrometer 100c of the present embodiment further includes a transflective assembly 140, which is removably disposed on a housing 110c, and the transflective assembly 140 includes a holder 142 and a cuvette 144. The cuvette 144 is configured to contain the sample to be measured, such as liquid to be measured, and the cuvette 144 is fixed on the holder 142 and attached to the measurement surface S2 of the spectrum measurement module 120. Here, the cuvette 144 is, for example, a cuvette with a short optical path (for example, 1 mm optical path). The optical path of the cuvette represents the containing thickness of the liquid to be measured, not including the thickness of the cuvette itself. For example, in the present embodiment, the optical path of 3.5 mm including the thickness of the cuvette itself is the thickness of the liquid to be measured plus the thickness of the cuvette itself, which is the total thickness of the cuvette. The disclosure does not limit the total thickness of the cuvette, and a corresponding design for the thickness of the cuvette is made according to actual conditions.

In the present embodiment, the housing 110c includes at least one first component (two first components 111 are shown schematically), and the transflective assembly 140 includes at least one second component (two second components 141 are shown schematically). There is a magnetic attraction between the first component 111 and the second component 141 to force the transflective assembly 140 to be attached on the housing 110c. Preferably, one of the first component 111 and the second component 141 is a permanent magnet, and the other of the first component 111 and the second component 141 is a magnetically sensitive component. Here, as shown in FIG. 3B, the first component 111 and the second component 141 are respectively embedded in the housing 110c and in the holder 142 of the transflective assembly 140, but the positions of the first component 111 and the second component are not limited here.

Further, the housing 110c of the present embodiment has a positioning groove 114, and the transflective assembly 140 further includes a positioning component 145. The positioning component 145 is disposed in the positioning groove 114 such that the transflective assembly 140 is positioned on the housing 110c. The positioning groove 114 is configured such that the transflective assembly 140 is limited at a specific position, which may increase the consistency between a position of the measurement surface S2 of the spectrum measurement module 120 and a relative position of the liquid to be measured.

Referring to FIG. 3C and FIG. 3F at the same time, the holder 142 of the transflective assembly 140 of the present embodiment includes multiple first limiting components 143a. The cuvette 144 has a first end T1 and a second end T2 opposite to each other. The first limiting components 143a abut on two opposite sides of the first end T1 so as to prevent the cuvette 144 from being displaced during the measurement process. And the second end T2 of the cuvette 144 abuts against a supporting surface S of the positioning component 145. In other words, the positioning component 145 may also serve as a support for the cuvette 144 in addition to positioning the transflective assembly 140.

Furthermore, when performing transflective measurement, the liquid to be measured must be filled into the cuvette 144 from the first end T1 of the cuvette 144. After that, the cuvette 144 with the liquid to be measured is placed in the holder 142, that is, the second end T2 of the cuvette 144 is inserted into the positioning component 145. Then, by using the magnetic force to fix the transflective assembly 140 to the housing 110c, the light can penetrate the liquid to be measured and then the light having the spectral information of the liquid to be measured can be reflected back to the spectrum measurement module 120.

Please refer to FIG. 3C, FIG. 3D and FIG. 3E at the same time. The holder 142 of the transflective assembly 140 of the present embodiment further includes multiple second limiting components 143b. The transflective assembly 140 further includes a reference white sample holder 146 and a reference white sample 148. The reference white sample holder 146 is disposed between the cuvette 144 and the holder 142 and has a containment groove 147. The second limiting components 143b limit the position of the reference white sample holder 146 so as to ensure that the light source in the spectrum measurement module 120 may be projected on the reference white sample 148, and that the reference white sample 148 is projected at the same position every time. The reference white sample 148 is disposed inside the containment groove 147 of the reference white sample holder 146. Here, the reference white sample 148 is, for example, a white ceramic sheet or a white reflectance sheet, but the disclosure is not limited thereto. In particular, the reference white sample holder 146 is configured to fix and protect the reference white sample 148, wherein the reference white sample holder 146 may be fixed on the holder 142, and may be taken out when performing the diffuse reflectance measurement of the reference white sample signal, as shown in FIG. 2B.

Further, the reference white sample holder 146 of the present embodiment further includes at least one glue groove (two glue grooves 149 are schematically shown), wherein the reference white sample 148 is fixed inside the containment groove 147 through a glue placed inside the glue groove 149. Here, the reference white sample holder 146 has a first surface B1, and the reference white sample 148 has a second surface B2. The second surface B2 protrudes by a height H′ relative to the first surface B1. Preferably, the height H′ is between 0.05 mm and 1 mm. Since the second surface B2 of the reference white sample 148 is higher than the first surface B1 of the reference white sample holder 146, the cuvette 144 containing the liquid to be measured can first directly contact the reference white sample 148, such that the spectrometer 100c of the present embodiment have obtain better spectral quality.

Referring to FIG. 3C and FIG. 3D at the same time, the holder 142 of the transflective assembly 140 of the present embodiment further includes multiple locking components 143c, wherein the locking components 143c are configured to lock the reference white sample holder 146. The locking components 143c are configured to prevent the reference white sample holder 146 from falling off, and the locking components 143c may allow the reference white sample holder 146 to be locked to or be taken out from the locking components 143c. In addition, the transflective assembly 140 of the present embodiment further includes an elastic component F disposed between the holder 142 and the reference white sample holder 146. Here, the elastic component F includes a compressed foam or a spring. The reaction force generated by the elastic component F is used to press the reference white sample holder 146 and the cuvette 144 such that the cuvette 144 is completely attached to the measurement surface S2 of the spectrum measurement module 120.

In short, the transflective assembly 140 of the present embodiment integrates the reference white sample 148 and the cuvette 144 into an independent module, which may be directly magnetically attracted to the diffuse reflectance spectrum measurement module 120 such that the transflective measurement may be performed when measuring the liquid to be measured. On the other hand, when not measuring the liquid to be measured, the independent module may also be integrated with the diffuse reflectance spectrum measurement module 120 to form a transflective integrated device, and the transflective assembly 140 may be a protection cover of the diffuse reflectance spectrum measurement module 120, which, in additional to being convenient to carry, may also protect the diffuse reflectance spectrum measurement module 120 so as to prevent the measurement surface S2 from being contaminated. Moreover, since the spectrometer 100c of the present embodiment has the reference white sample 148, it means that the transflective assembly 140 includes the reference white sample 148, wherein the reference white sample 148 can be used in both reflectance measurement and transflective measurement.

When the reference white sample 148 is not used, the transflective assembly 140 may be removed from the housing 110c. At this time, the reference white sample 148 is stored in the holder 142 of the transflective assembly 140, such that it may not be easily lost or contaminated. In other words, when transflective measurement is not needed, the transflective assembly 140 may be separated from the diffuse reflectance spectrum measurement module 120, which may not affect the placement of the sample to be measured during the diffuse reflectance measurement.

In summary, the embodiments of the disclosure have at least one of the following advantages or effects. In the design of the spectrometer of the disclosure, the measurement surface of the spectrum measurement module is exposed from the opening of the housing, and there is a height difference between the measurement surface and the arrangement surface. Thereby, it may be ensured that the sample to be measured may first contact the measuring surface without being affected by the housing. Furthermore, the spectrometer of the disclosure may include a reference white assembly or a reference white sample, which may be directly placed or magnetically attached to the diffuse reflectance spectrum measurement module so as to perform a transflective measurement when measuring the liquid to be measured. On the other hand, when not measuring the liquid to be measured, it may also be integrated with the diffuse reflectance spectrum measurement module to form a transflective integrated device, such that the transflective assembly may be a protection cover of the diffuse reflectance spectrum measurement module, which, in additional to being convenient to carry, may also protect the diffuse reflectance spectrum measurement module so as to prevent the measurement surface from contaminated.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A spectrometer, comprising a housing and a spectrum measurement module, wherein
the housing has an arrangement surface and an opening; and
the spectrum measurement module is disposed in the housing and has a measurement surface, wherein the measurement surface is exposed from the opening of the housing, and there is a height difference between the measurement surface and the arrangement surface.

2. The spectrometer according to claim 1, wherein the height difference is between 0.1 mm and 5 mm.

3. The spectrometer according to claim 1, the spectrometer further comprising a reference white assembly, wherein
the reference white assembly is detachably disposed on the measurement surface of the spectrum measurement module.

4. The spectrometer according to claim 3, wherein the reference white assembly comprises a reference white sample holder and a reference white sample, wherein
the reference white sample holder has an containment groove;
the reference white sample is disposed in the containment groove of the reference white sample holder.

5. The spectrometer according to claim 4, wherein the reference white sample holder further has at least one glue groove, and the reference white sample is fixed inside the containment groove through a glue placed inside the at least one glue groove.

6. The spectrometer according to claim 4, wherein the reference white sample holder has a first surface, the reference white sample has a second surface, and the second surface protrudes a height from the first surface.

7. The spectrometer according to claim 6, wherein the height difference is between 0.05 mm and 1 mm.

8. A spectrometer, comprising a housing, a spectrum measurement module, and a transflective assembly, wherein
the housing has a arrangement surface and an opening;
the spectrum measurement module is disposed in the housing and has a measurement surface, wherein the measurement surface is exposed from the opening of the housing, and there is a height difference between the measurement surface and the arrangement surface; and
the transflective assembly is detachably assembled on the housing and comprises a holder and a cuvette, wherein the cuvette is configured to contain liquid to be measured, and the cuvette is configured to be fixed on the holder and attached to the measurement surface of the spectrum measurement module.

9. The spectrometer according to claim 8, wherein the height difference is between 0.1 mm and 5 mm.

10. The spectrometer according to claim 8, wherein the housing comprises at least one first component, and the transflective assembly comprises at least one second component, wherein there is a magnetic attraction between the at least one first component and the at least one second component, as to force the transflective assembly to be attached on the housing.

11. The spectrometer according to claim 10, wherein one of the at least one first component and the at least one second component is a permanent magnet, and the other of the at least one first component and the at least one second component is a magnetically sensitive component.

12. The spectrometer according to claim 8, wherein the housing has a positioning groove, and the transflective assembly further comprises a positioning component, wherein the positioning component is disposed in the positioning groove, such that the transflective assembly is positioned on the housing.

13. The spectrometer according to claim 12, wherein the holder of the transflective assembly comprises a plurality of first limiting components, and the cuvette has a first end and a second end opposite to each other, wherein the plurality of first limiting components abut on two opposite sides of the first end, and the second end of the cuvette abuts on the positioning component.

14. The spectrometer according to claim 13, wherein the holder of the transflective assembly further comprises a plurality of second limiting components, and the transflective assembly further comprises a reference white sample holder and a reference white sample, wherein
the reference white sample holder is disposed between the cuvette and the holder, the reference white sample holder has an containment groove, and a position of the reference white sample holder is limited by the plurality of second limiting components; and
the reference white sample is disposed in the containment groove of the reference white sample holder.

15. The spectrometer according to claim 14, wherein the reference white sample holder further has at least one glue groove, and the reference white sample is fixed inside the containment groove through a glue placed inside the at least one glue groove.

16. The spectrometer according to claim 14, wherein the reference white sample holder has a first surface, the reference white sample has a second surface, and the second surface protrudes a height relative to the first surface.

17. The spectrometer according to claim 16, wherein the height difference is between 0.1 mm and 5 mm.

18. The spectrometer according to claim 14, wherein the holder of the transflective assembly further comprises a plurality of locking components, and the reference white sample holder is locked by the plurality of locking components.

19. The spectrometer according to claim 14, wherein the transflective assembly further comprises an elastic component, and
the elastic component is disposed between the holder and the reference white sample holder.

20. The spectrometer according to claim 19, wherein the elastic component comprises a compressed foam or a spring.
